(19) United States
(12) Patent Application Publication
(10) Pub. No.: US 2004/0050372 A1
(43) Pub. Date: Mar. 18, 2004

(54) Motor vehicle fuel system

(76) Inventor: Lynfel James Owen, Warwickshire (GB)

Correspondence Address: FORD GLOBAL TECHNOLOGIES, LLC., SUITE 600 - PARKLANE TOWERS EAST, ONE PARKLANE BLVD., DEARBORN, MI, 48126, US

(21) Appl. No.: 10/660,387

(22) Filed: Sep. 11, 2003

(30) Foreign Application Priority Data
Sep. 12, 2002 (GB) 0221083.9

(51) Int. Cl. F02M 33/02

(52) U.S. Cl. 123/518

(57) ABSTRACT

A system for reduction of vapour release during vehicle fuelling is presented. The system includes a fuel tank, an inlet duct with its lower end attached to the fuel tank for introducing fuel into the tank and a porous flexible sock attached to the lower end of the inlet duct by means of a connector. The porosity of the sock is such that a substantial proportion of the incoming fuel flows through the wall of the sock. Because this flow is over a large area, the velocity is low and therefore results in a reduction of gasses and vapours generated during vehicle fuelling.

### FIELD OF INVENTION

The invention relates to motor vehicle fuel systems, and more particularly to reducing the release of fuel gases and vapours during the filling of the fuel tank.

### BACKGROUND OF THE INVENTION

A typical motor vehicle fuel system includes a fuel tank and a pipe, generally known as a filler neck, which extends from a convenient position on the outside of the vehicle and opens into the tank for introducing liquid fuel into the tank. A problem with such fuel system is that gases and fuel vapours are released during the filling of the tank. Certain types of filling apparatus capture and monitor release of such gases and vapours to cut off the fuel delivery if the volume of gas and vapour release exceeds a particular rate. This can be an impediment to the effective filling of the fuel tank, particularly when the vehicle is being fuelled for the first time on the vehicle production line.

### SUMMARY OF THE INVENTION

Accordingly, the present invention is directed to a motor vehicle fuel system in which the release of gases and vapours can be reduced, including a fuel tank, an inlet duct having an upper end for receiving liquid fuel from a fuel dispensing apparatus and a lower end opening into said fuel tank for introducing liquid fuel into said fuel tank and a sock of a porous flexible material attached at one end to said lower end of said inlet duct.

In one embodiment of the present invention, the sock is open at its other end.

In another embodiment of the present invention, the sock extends substantially to the base of the fuel tank when the fuel tank is empty.

In yet another embodiment of the present invention, the sock has porosity equivalent to filtration in the range 20 to 80 micron (μm) and preferably about 50 micron μm).

Therefore, according to the present invention, when the tank is being filled the fuel tends to fill out the inside of the sock as the fuel is ducted through it. The incoming fuel brings with it gases and vapours which are released as the fuel flows through the sock into the fuel tank. Hence this fuel is an effervescent two-phase mixture, which is of lower density than the liquid fuel already in the tank so that as the fuel level rises the sock floats to the surface of the fuel contained in the fuel tank. This allows the fuel to flow onto the fuel surface rather than splash down onto it. Moreover, the porosity of the sock is such that a substantial proportion of the incoming fuel flows through the wall of the sock. Because this flow is over a large area, the velocity is low and there is a reduced tendency for gases and vapours to be released. Further, due to the reduction in the release of gases and vapours, there is a reduced backflow through the vent pipe so that the tank can be fuelled at a reasonable rate without triggering the automatic cut off mechanism used in the filling apparatus.

An advantage of the present invention is a reduction in release of vapours during the fuelling of the vehicle.

### BRIEF DESCRIPTION OF THE DRAWINGS

The advantages described herein will be more fully understood by reading an example of an embodiment in which the invention is used to advantage, referred to herein as the Description of Preferred Embodiment, with reference to the drawings, wherein:

FIG. 1 is a diagrammatic cross section of a fuel tank and a filler neck of a motor vehicle fuel system according to the invention with certain components omitted for clarity;

FIG. 2 is a view based on FIG. 1 showing an empty fuel tank and with a porous flexible tubular sock in place;

FIG. 3 is a view similar to FIG. 2 showing the fuel tank during filling;

FIG. 4 is a perspective view of a filler neck connector as filled to the fuel tank shown in FIGS. 1 to 3; and

FIG. 5 is a side elevation of the filler neck connector shown in FIG. 4.

### DESCRIPTION OF THE PREFERRED EMBODIMENT(S) OF THE INVENTION

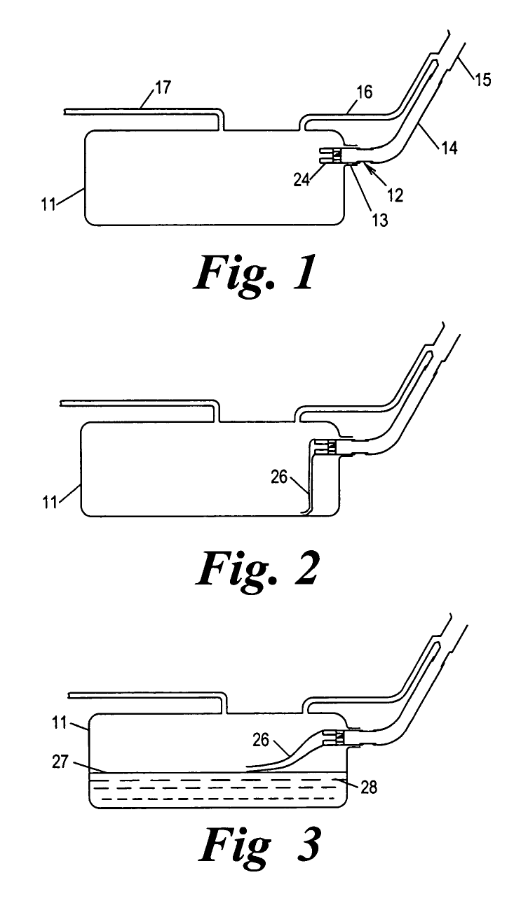

In FIG. 1, a motor vehicle fuel tank 11 has a filler neck connector 12 secured (e.g., by welding or adhesive) to a flared collar 13 formed as part of the tank 11. A filler neck 14 is connected to the neck connector 12 and to a filler head 15, which incorporates a conventional valve to avoid fuel spillage, the filler head 15, filler neck 14 and neck connector 12 together forming an inlet duct for the tank 11. A vent pipe 16 connects from the top of the tank 11 to the filler head 15 to allow gases and vapours to escape from the space above the fuel, these gases and vapours being removed by the filling apparatus at the filling station. A breather pipe 17 is connected to an engine of the vehicle through a carbon canister filter in a conventional manner.

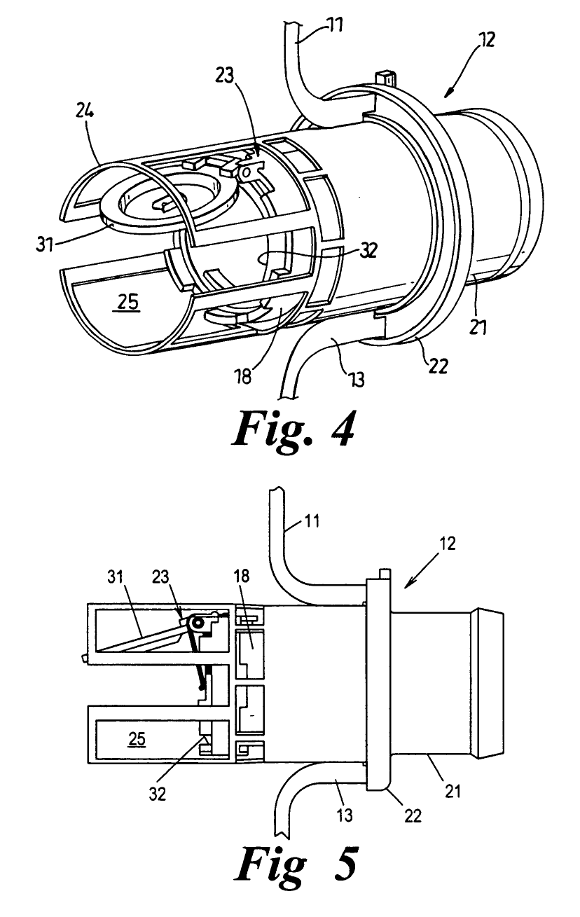

The filler neck connector 12, as is more clearly shown in FIGS. 4 and 5, comprises a tubular body 18 having a stub 21 for connecting the filler neck 14 and a flange 22 welded to the collar 13. A check valve 23 having a spring-loaded flap 31 which normally covers an exit orifice 32 in the filler neck body 18 is provided to prevent backflow of liquid fuel. As described so far, the neck connector 12 is conventional. However, in accordance with the invention, there is a tubular support cage 24 of moulded plastics material including a portion with a solid wall and an open portion with windows 25 in the region of the check valve 23. The cage is secured to the connector flange 22 at the solid wall end, e.g. by friction welding, to leave an annular space between the cage 22 and the tubular body 18.

The cage 24 is used to support and retain one end of a tubular duct or sock 26 of a porous flexible material, e.g., a woven nylon mesh. FIG. 1 shows the tank 11 and associated components without the sock 26 whereas FIG. 2 shows the sock 26 in place when the tank 11 is empty. The sock has a mesh size equivalent to 50 micron (μm) filtration and is open at its other end, i.e., the end remote from the filler neck 14. Conveniently the sock 26 is secured to the cage 24 by placing the sock over a mandrel and overmoulding the cage onto it. In this way the sock 26 is also secured to the cage 24 in the region of the windows 25.

The flexibility of the sock 26 is such that it hangs down limply when the tank is empty, as depicted in FIG. 2, but when the tank 11 is being filled the fuel tends to fill out the inside of the sock as the fuel is ducted through it. The incoming fuel brings with it gases and vapours which are released as the fuel flows down the filler neck 14 and through the sock 26 itself. Hence, this fuel is an effervescent two-phase mixture, which is of lower density than the liquid fuel already in the tank so that as the fuel level rises, the sock 26 floats to the surface 27 of the fuel 28 contained in the tank 11. This allows the fuel to flow onto the fuel surface 27 rather than splash down onto it. Moreover, the porosity of the sock 26 is such that a substantial proportion of the incoming fuel flows through the wall of the sock 26. Because this flow is over a large area, the velocity is low and there is a reduced tendency for gases and vapours to be released. The windows 25 in the support cage 24 are immediately adjacent the flap of the check valve 23 and this allows some of the liquid fuel to flow through the windows sock 26 as it emerges through the check valve orifice 32 and also prevents the sock interfering with the action of the check valve flap 31.

By reducing the release of gases and vapours, there is a reduced backflow through the vent pipe 16 so that the tank can be fuelled at a reasonable rate without triggering the automatic cut off mechanism used in the filling apparatus. This is particularly useful where the filler head 15 and the associated filling apparatus is of the fully sealed type where all the gases and vapours are collected without escaping to the atmosphere.

The material of the sock 26 may be of a mesh size equivalent to filtration in the range 20-80 micron (μm) and whilst a woven material providing 50 micron (μm) filtration is preferred, appropriate knitted material may be found to perform satisfactorily. In general, if the porosity of the material is too great, the fuel tends to spray through the wall of the sock 26 so its effect in reducing the release of gases and vapour is impaired. Conversely, if the porosity of the material is too low, the majority of the fuel flow is through the end of the sock and this can result in an unwanted back-pressure.

The length of the sock 26 is preferably such that it should just touch the base of the tank 11 when hanging with the tank empty as in FIG. 2. In a typical vehicle installation this is about 300 mm. The sock 26 may be longer than this but should preferably not exceed the width of the tank 11, i.e., it should extend no further than the wall opposite the filler neck 14, and provided that the back-pressure is not increased unduly. Other constraints may be relevant, e.g., avoiding the fuel pump module and in practice the optimum length can be determined by trial and error during vehicle development. The diameter of the sock 26 is typically about 50 mm, this being a convenient size for the sock and its cage to fit over the filler neck connector body 18.

Although a sock 26 with an open end is shown and described, the sock may have a closed end if the required flow rate is such that the back-pressure is not increased unduly and the velocity of the fuel flow through the wall of the sock is not such that this induces undue release of gases and vapours. This might be achieved by using a sock of a larger diameter, thereby increasing the effective area for flow though the sock wall.

What is claimed is:

1. A motor vehicle fuel system, comprising:
a fuel tank;
an inlet duct having an upper end for receiving liquid fuel from a fuel dispensing apparatus and a lower end opening into said fuel tank for introducing liquid fuel into said fuel tank;
and a porous flexible sock attached at one end to said lower end of said inlet duct.

2. The fuel system according to claim 1 wherein said sock is open at its other end.

3. The fuel system according to claim 2 wherein said sock extends substantially to a bottom of said fuel tank when said fuel tank is empty.

4. The fuel system according to claim 3 wherein said sock has a porosity equivalent to filtration in the range 20 to 80 micron (μm)

5. The fuel system according to claim 4 wherein said porosity is substantially equivalent to 50 micron (μm) filtration.

6. The fuel system according claim 1 further comprising a connector coupled to said lower end of said inlet duct, said connector comprising a check valve.

7. A fuel system according to claim 6 wherein said check valve includes a spring-loaded flap covering an exit orifice of the of said connector.

8. The fuel system according to claim 7 wherein said connector further comprises a support cage.

9. The fuel system according to claim 8 wherein said support cage comprises a first portion and a second portion, wherein said first portion is solid and said second portion has windows.

10. The fuel system according to claim 9 wherein said windows of said second portion of said support cage are immediately adjacent to said check valve.

11. The fuel system according to claim 10 wherein said connector connects said sock to said lower end of said inlet duct.

12. The fuel system as set forth in claim 11 wherein said windows of said second portion of said support cage are covered by said sock.
